(19) United States
(12) Patent Application Publication
(10) Pub. No.: US 2009/0016540 A1
(43) Pub. Date: Jan. 15, 2009

(54) AUDITORY PERCEPTION CONTROLLING DEVICE AND METHOD

(75) Inventors: Soren Heningsen Nielsen, Lystrup (DK); Esben Skovenborg, Arhus (DK)

Correspondence Address: CANTOR COLBURN, LLP, 20 Church Street, 22nd Floor, Hartford, CT, 06103, US

(73) Assignee: TC ELECTRONICS A/S, RISSOV (DK)

(21) Appl. No.: 12/162,076

(22) PCT Filed: Jan. 23, 2007
(86) PCT No.: PCT/DK2007/050007

§ 371 Date: Jul. 24, 2008

(30) Foreign Application Priority Data
Jan. 25, 2006 (US) 60761877

(51) Int. Cl. H04R 29/00

(52) U.S. Cl. 381/56

(57) ABSTRACT

“A method of automatically performing adjustment of audio control settings in an audio system, whereby at least a part of the audio control settings is adjusted according to automatic audio control setting adjustment routines via at least one remote control receiver of the audio system;
an audio system including audio control settings and at least one remote control receiver, wherein an auditory perception controlling device is arranged for automatically adjusting at least a part of the audio control settings via at least one of the at least one remote control receiver;
an auditory perception controlling device including at least one input means, a processing unit and an emitter, wherein the processing unit cooperates with the emitter to establish remote control signals upon fulfilment of predefined, user defined or dynamically determined conditions regarding data received by at least one of the at least one input means, wherein at least one of the at least one input means includes a receiver for receiving remote control signals, a microphone for measuring surrounding sound or an input connector for receiving an audio signal.”

### TECHNICAL FIELD OF THE INVENTION

The present invention relates to automatic control of an audio system by means of remote control signals in order to improve the auditory perception such as, e.g., loudness, annoyance and intelligibility.

### BRIEF SUMMARY OF RELATED ART

When listening to audio rendered by common audio systems such as, e.g., stereo sets, television sets, radios, etc., it is a common experience that audio from different sources and/or channels is perceived differently, e.g. as regards loudness, annoyance, intelligibility and other perception properties. It is further well-known that such properties may also fluctuate with time, e.g. increased loudness during commercial breaks, etc. The auditory perception may also be altered by, e.g., environmental properties such as, e.g., background noise, etc., and some of the properties may be influenced and/or limited by other considerations, such as, e.g., decreased loudness during night time due to neighbours, decreased annoyance when using the audio as mere background sound, etc.

In most standard audio systems the auditory perception may be altered by modifying standard parameters of the audio system such as volume, bass and treble, etc. Typically, this may be done by using a remote control. The user does, however, need to perform the desired and/or necessary adjustments every time the circumstances change, e.g. when a commercial break occur, when the source or channel is changed, when the neighbours may be expected to go to sleep, when a noisy apparatus or environment, e.g. a cooker hood or a busy main road, is present, etc., and when these change back to normal again. The necessity of constantly performing these adjustments is for most people disturbing and annoying, and a further characteristic of the adjustments is that the auditory perception adjustments performed as a response to a particular event, e.g. changing the source from TV to radio, is almost the same every time. For example, a particular user always increases the volume by four steps when the cooker hood is started, always decreases the volume by seven steps when a commercial break occur, always increases the volume by five steps and the bass by three steps when switching to MTV (a music television channel), etc. A problem in the known art is that the user has to do these auditory perception controlling adjustments manually, even though the adjustments are often predictable.

A few specialised audio systems comprise auditory perception controlling features, especially for controlling loudness, but such systems are often expensive and their use highly advanced. Furthermore, such systems do not facilitate controlling auditory perception of different signal sources.

Also devices that facilitate controlling a specific auditory perception property, such as loudness, upon occurrence of a specific, predetermined event are known. Such a product is, e.g., a known device for decreasing loudness during commercial breaks. Problems of such devices typically comprise their limited use and that they require to be placed in the signal line, e.g., between a CD-player and an amplifier, between a television and an amplifier, between an amplifier and speakers, etc. This may cause degradation in audio quality, and the physical connection requirements may be hard to fulfil in all setups, and especially with several audio sources.

### BRIEF SUMMARY OF THE INVENTION

The invention provides a device that automatically controls auditory perception properties. The invention further provides an auditory perception controlling device that operates by remote control techniques, i.e. without physical implementation into the signal path. Still further, the invention provides an auditory perception controlling device that is able to control several different conventional audio systems. The invention also provides an auditory perception controlling device that acts on several different kinds of events and circumstances, e.g. source, channel, content, background noise, time, etc.

The present invention relates to a method of automatically performing adjustment of audio control settings in an audio system, whereby at least a part of said audio control settings is adjusted according to automatic audio control setting adjustment routines via at least one remote control receiver of said audio system.

By the present invention is provided an advantageous method of automatically controlling audio control settings in an audio system via remote control means, thereby, e.g., enabling automatic control of sound established by the audio system, in particular control of the auditory perception of the sound, without requiring specialised audio subsystems or additional signal processing components in the audio signal path. In other words, by the present invention any remote controllable audio system is enabled to have its audio settings controlled automatically in addition to the manual control. The present invention is applicable to any remote controllable audio system, regardless of its value, complexity, location or use, and may thus be used with anything from headsets and mobile audio systems over vehicle audio systems, e.g. in cars or boats, low-cost or HIFI home audio systems and home cinemas to large scale and professional audio systems for cinemas, auditoriums, PA-systems, etc.

According to the present invention, audio control settings in an audio system may, e.g., comprise volume or gain settings, bass and treble settings, equalization settings, muting, mono/stereo/surround sound settings, dynamic range control settings, or any other available settings that at least partly, directly or indirectly, control the audio processing and reproduction of sound.

According to the present invention, automatically performing audio control settings adjustments may comprise any way of controlling the audio control settings without requiring explicit manual interaction for each control command. Automatic audio control setting adjustment routines may thus comprise, e.g., macro-like routines, artificial intelligence like routines, adaptive control routines, etc. Macro-like routines may, e.g., comprise performing one or more predetermined adjustments automatically as a reaction to a predetermined manual input, e.g. performing a volume decrease automatically when the user changes to a specific TV channel, or performing a mute command when a predetermined word is picked up by a microphone. Artificial intelligence like routines and adaptive control routines may, e.g., comprise performing one or more adjustments automatically as a reaction to predetermined or dynamically determined implicit or indirect kinds of input, e.g. time of the day, loudness level measured by microphone, kind of audio content estimated from an audio signal or microphone, background noise determined by means of microphone, etc., or a combination of such inputs.

According to the present invention, a remote control receiver may be any means of an audio subsystem for receiving audio control settings control commands from outside the audio subsystem itself, e.g. from a remote control communicating by infrared light, ultrasound, radio waves, Bluetooth, microwaves, wireless or wired network, data cables, etc. Typically, the remote control receiver of an audio subsystem according to the invention is a standard infrared remote control receiver.

Hence, when audio control settings of an audio system are adjusted automatically via the common remote control receiver of the audio system, an advantageous invention is obtained.

When said audio control settings control auditory perception of audio established by said audio system 21, an advantageous embodiment of the present invention has been obtained.

According to the present invention, control of auditory perception of audio established by an audio system may comprise control of properties such as, e.g., in particular, loudness, annoyance and intelligibility, but also sharpness, perception intensity, airiness, brilliance, timbre, clarity, presence, liveness, warmth, fullness, spaciousness, etc.

When said method involves obtaining a predetermined auditory perception of sound established by said audio system 21 by said adjustment of audio control settings, an advantageous embodiment of the present invention has been obtained.

By providing automatic control of auditory perception properties, e.g. loudness, according to the present invention, e.g. for maintaining a desired loudness when changing TV channel or audio source, reducing the loudness when commercial breaks occur, or improving intelligibility when background noise disturb the perception, the convenience experienced by using such an audio system may be significantly improved.

When said audio system 21 comprises at least one remote controllable audio subsystem 22, an advantageous embodiment of the present invention has been obtained.

According to the present invention, several audio subsystems which together form the audio system may be controlled. Several of the audio subsystems may comprise remote control receivers and audio control settings, and be subject to individual control according to the method of the present invention. The different audio subsystems may be connected to each other, and possibly share a common power amplifier and set of loudspeakers, or they may each comprise individual power amplifiers and loudspeakers or other sound reproduction means. In a typical surround sound HIFI setup, all audio subsystems, e.g. a television set, a DVD-player, a hard disk recorder, a CD-player, an FM radio receiver, etc., shares a common multi-channel power amplifier and a common set of, e.g., 5+1 loudspeakers. A method according to the present invention may control most auditory perception properties, e.g. loudness, merely by controlling the audio control settings of the common power amplifier, but may in more advanced embodiments further control audio control settings of the individual audio subsystems, e.g. in order to achieve an auditory perception not possible with only the audio control settings available in the power amplifier. However, a typical low-cost living room audio system often comprises, to a higher degree, separate, i.e. not connected, audio subsystems, e.g. a television set comprising its own set of built-in loudspeakers and a stereo set, e.g. comprising an FM radio receiver and a CD-player, comprising its own power amplifier and two loudspeakers distributed in the room. In such an audio system, the audio control settings in one audio subsystem does not influence audio reproduced by the other audio subsystem. Thus, to control auditory perception properties, e.g. loudness, an embodiment of the present invention has to control several sets of audio control settings. It is noted that this is a quite straightforward implementation of the present invention, and does not constitute a problem as long as no problem exists regarding manual remote control of the different audio subsets. Only if manual control is problematic, e.g. if the typical several remote control devices interfere with each other, and a command intended for one audio subset causes an unexpected and unintended adjustment in another audio subset, these problems may obviously also exist with an embodiment of the present invention. If, however, such simultaneous adjustments in several audio subsets are intended, an embodiment of the present invention may also be able to handle and exploit such functionality.

When said at least one remote control receiver 23 is a wireless remote control receiver, an advantageous embodiment of the present invention has been obtained.

According to a preferred embodiment of the present invention, the remote control of audio control settings is performed by one or more wireless technologies, e.g. infrared light, ultrasound, radio waves, Bluetooth, microwaves, wireless network, etc.

When said at least one remote control receiver 23 is an infrared remote control receiver, an advantageous embodiment of the present invention has been obtained.

According to an even more preferred embodiment of the invention, the remote control of audio control settings is performed by absolutely common infrared remote control technologies applicable to almost any audio system or subsystem available. By providing a method for controlling audio control settings automatically via infrared remote control technology, such method may be applied to practically all audio systems.

When said adjusting according to automatic audio control setting adjustment routines via said at least one remote control receiver 23 is performed by an auditory perception controlling device 10, an advantageous embodiment of the present invention has been obtained.

According to a preferred embodiment of the present invention, a separate device, an auditory perception controlling device, is provided for carrying out a method according to the present invention. Thereby any remote controllable audio system may be enhanced with a method according to the present invention.

When said adjusting according to automatic audio control setting adjustment routines is at least partly based on data obtained by monitoring at least one input means 12, 41, 51, 70, an advantageous embodiment of the present invention has been obtained.

According to the present invention, the audio control settings are adjusted automatically, which requires means for determining when, which and how settings should be adjusted. Contrary to explicit manual control, the automatic control method of the present invention may comprise monitoring of one or more of several possible input means for determining when, which and how audio control settings should be adjusted.

When said auditory perception controlling device 10 comprises said input means 12, 41, 51, 70, an advantageous embodiment of the present invention has been obtained.

According to a preferred embodiment of the present invention, one or more input means are arranged in the separate auditory perception controlling device thus providing a self-contained device for performing a method according to the present invention.

When said input means 12, 41, 51, 70 comprises a receiver 12 for receiving remote control signals 14, an advantageous embodiment of the present invention has been obtained.

According to a preferred embodiment of the present invention, one input means comprises a remote control receiver enabling automatic control of audio control settings based on what other remote control commands are transmitted to the audio system. When the remote control receiver is arranged in an auditory perception controlling device, that device is enabled to monitor the remote control commands given manually by the users of the audio system, and base the automatic audio control setting adjustment thereon, e.g. by learning typical user behaviour.

When said adjusting according to automatic audio control setting adjustment routines is at least partly based on acquired information about at least one user's typical use of said audio system, an advantageous embodiment of the present invention has been obtained.

According to the present invention, information about a user's typical behaviour may preferably be acquired from monitoring remote control commands given manually by the user, e.g. by means of a receiver. By acquiring such information, the automatic control may be based on adaptively or dynamically modified routines based on that information.

When said adjusting according to automatic audio control setting adjustment routines is at least partly based on predefined routines, an advantageous embodiment of the present invention has been obtained.

According to an embodiment of the present invention, the automatic control is based on predefined routines, e.g. regarding adjustments to perform upon occurrence of events to which most users presumably would react similarly, e.g. reducing loudness when commercial breaks occur, increasing loudness and/or improving intelligibility when background noise exceeds a certain limit, etc. In a preferred embodiment of the present invention, both adaptively or dynamically modified routines, e.g. learned routines, and predefined routines are provided, and an appropriate routine may be selected according to one or more conditions, e.g. regarding the event encountered, the time, whether any behavioural information about that event has previously been gathered or any learned routine exists, etc.

When said adjusting according to automatic audio control setting adjustment routines is at least partly based on monitoring surrounding sound 42, an advantageous embodiment of the present invention has been obtained.

According to a preferred embodiment of the present invention, surrounding sound is monitored, thereby enabling basing the adjustment routine on information derivable from the surrounding sound. Such information may, e.g., comprise the occurrence of events which may cause an automatic adjustment to be performed, e.g. a telephone that rings, which may cause a mute command to be given automatically, the background noise exceeding a certain limit, which may cause a loudness increase to be performed automatically, a commercial break interrupting, which may cause a loudness reduction to be performed automatically, a predefined word, which may cause a certain routine to be performed, etc. The information derived from the surrounding sound may further comprise additional information to apply when selecting if and which routine to perform upon the occurrence of other events, e.g. for determining exactly how much to modify the loudness when the user changes audio source, exactly how much to reduce the loudness after, e.g., 11 PM, etc.

When said adjusting according to automatic audio control setting adjustment routines is at least partly based on monitoring the time, an advantageous embodiment of the present invention has been obtained.

According to a preferred embodiment of the present invention, the performance of adjustment routines may be based on the time. This may, e.g., be advantageous for automatically ensuring a loudness decrease at evening and night time, or certain adjustments to be made at predetermined intervals or after a predetermined time of use, etc. The time may also advantageously be associated with learned typical user behaviour routines, as a user may behave differently at different times of the day. For example in an embodiment of the present invention it is learned that when a user listens to radio in the morning, the loudness should be relatively low and when the user watches TV, e.g. music television MTV, in the late afternoon, the loudness should be relatively high.

When said adjusting according to automatic audio control setting adjustment routines is at least partly based on monitoring an audio signal 52 from said audio system 21, an advantageous embodiment of the present invention has been obtained.

According to an embodiment of the present invention, the audio signal currently processed by the audio system, or a signal derived from it, is provided to the automatic audio control setting adjustment routine for facilitating the decision making. From such an audio signal, e.g., information about the relative loudness or other audio perception properties of the sound reproduced in the room, or information about the content of the audio signal, e.g. commercials, dialog, music, action effects, may be derived. If such an audio signal from the audio system is provided in a system where also a microphone input is available, it is possible to substantially eliminate the audio signal component from the microphone signal, e.g. by subtraction or component analysis, and thereby obtain information about the background noise and distinguish between noise, dialog, spoken commands, etc., originating from the surroundings or users, and the sound established by the audio system. The ability to make such distinctions may be very advantageous in that automatic adjustments may be made on the basis of background noise and other activity, instead of just the general sound present in a room. This may, e.g., be used for automatically reducing loudness when a dialog between users of the audio system is detected, but not if the dialog is part of the audio signal, i.e. originating from the audio system. A further example may comprise increasing loudness and/or improving intelligibility in the case of loud background noise, but not if the noise is part of the audio originating from the audio system.

When said adjusting according to automatic audio control setting adjustment routines is at least partly based on monitoring remote control signals 14 from at least one remote control 24 of said audio system 21, an advantageous embodiment of the present invention has been obtained.

In a preferred embodiment of the present invention, the automatic adjustment is based on the monitoring of remote control commands from one or more remote controls of the audio system. This feature enables learning typical user behaviour and subsequently start performing such behaviour automatically, thus substituting manual control. The feature may also be used for performing predefined adjustments when certain remote control commands are detected, in a macro-like fashion. Hence, simple commands of a common, manual remote control may be used for controlling the performance of advanced, possibly multiple, commands and adjustments according to the present invention, possibly on the basis of the current state of other input means, e.g. the present sound as monitored by a microphone, the current audio as monitored by an input connector, the current time, etc.

When said monitoring surrounding sound 42 comprises using a microphone 41 for measuring sound, an advantageous embodiment of the present invention has been obtained.

In a preferred embodiment of the present invention, the surrounding sound is measured by means of a microphone.

When said adjusting according to automatic audio control setting adjustment routines is at least partly based on monitoring user input via user input means 70, an advantageous embodiment of the present invention has been obtained.

In an embodiment of the present invention, a keypad, a number of buttons or knobs, a touch-sensitive display, or other user input means, is provided for allowing direct input from a user. In a preferred embodiment of the present invention, such a feature is provided in addition to other input means as described above, in order to enable configuration, resetting, programming, etc., or overriding automatic adjustments, indicating desired levels or auditory perception, etc.

When said method comprises learning at least one behaviour of at least one user of said audio system, associating each of said at least one behaviour with at least one condition, monitoring fulfilment of said at least one condition, and upon fulfilment of at least one of said at least one condition automatically repeating said associated behaviour, whereby said repeating a behaviour comprises automatically performing adjustment of audio control settings in said audio system 21, an advantageous embodiment of the present invention has been obtained.

According to the present invention, a behaviour of a user comprises, e.g., audio control setting adjustments typically performed by a user under certain conditions, e.g. that a user typically increases volume for certain TV channels, typically decreases volume when commercial breaks occur, typically increases bass boost when listening to music, typically enables surround sound when watching DVD's, typically configures the equalizer to a speech enhancing setting when listening to a radio talk show while the cooker hood is active, typically mutes the audio system when the phone rings, typically enables dynamic range compression and reduces volume when watching action movies at evening due to the neighbours, typically reduces volume when having a conversation in the room, etc.

According to the present invention, conditions associated with a behaviour may comprise one or more conditions regarding data received from any kind of input means, e.g. a remote control receiver, a microphone, an audio signal, a timer or a watch, a keypad or similar, etc. Conditions may, e.g., comprise a certain remote control command, e.g. change of channel or audio source, a certain background noise level, a certain general loudness, a certain content of the audio, e.g. commercials, a certain content of other sounds in the room, e.g. conversation, phone ring, etc.

By an embodiment of the present invention is provided an advantageous method of learning typical user behaviour and, by time, taking over such behaviour and automatically performing the adjustments until then performed manually by the user, thereby leaving to the user only to choose the channel or audio source, and not care about the related typically necessary adjustments.

When said method comprises monitoring surrounding sound 42 and upon said sound fulfilling predefined or user defined conditions automatically performing adjustment of audio control settings in said audio system 21, an advantageous embodiment of the present invention has been obtained.

Thereby is provided an advantageous method of automatically performing adjustments according to the user's predefined wishes, or wishes presumed by the manufacturer, under certain conditions regarding the present sound. In a preferred embodiment of the present invention, the conditions may be defined manually or they may be learned from monitoring typical user behaviour.

When said method comprises monitoring an audio signal 52 of said audio system 21 and upon said audio signal fulfilling predefined or user defined conditions automatically performing adjustment of audio control settings in said audio system 21, an advantageous embodiment of the present invention has been obtained.

Thereby is provided an advantageous method of automatically performing adjustments according to the user's predefined wishes, or wishes presumed by the manufacturer, under certain conditions regarding the audio currently processed by the audio system. In a preferred embodiment of the present invention, the conditions may be defined manually or they may be learned from monitoring typical user behaviour.

When said method comprises continuously monitoring fulfilment of one or more conditions regarding remote control signals, surrounding sound, audio signals from said audio system, time and/or user input and upon fulfilment automatically performing said adjustment of audio control settings in said audio system 21, an advantageous embodiment of the present invention has been obtained.

Thereby is provided an advantageous method of automatically performing adjustments when certain conditions are fulfilled, thereby taking over what is normally left to the user to do manually.

When said method comprises automatically controlling the loudness of sound established by said audio system 21, an advantageous embodiment of the present invention has been obtained.

According to a preferred embodiment of the present invention, auditory perception properties, and in particular loudness, is controlled automatically.

When said method comprises automatically controlling the intelligibility of sound established by said audio system 21, an advantageous embodiment of the present invention has been obtained.

When said method comprises automatically controlling the annoyance of sound established by said audio system 21, an advantageous embodiment of the present invention has been obtained.

When said audio control settings comprise gain settings, an advantageous embodiment of the present invention has been obtained.

When said audio control settings comprise bass and treble settings, an advantageous embodiment of the present invention has been obtained.

When said audio control settings comprise equalization settings, an advantageous embodiment of the present invention has been obtained.

When said audio control settings comprise mute settings, an advantageous embodiment of the present invention has been obtained.

When said audio control settings comprise mono, stereo and surround sound settings, an advantageous embodiment of the present invention has been obtained.

When said audio control settings comprise dynamic range control settings, an advantageous embodiment of the present invention has been obtained.

When said remote control receiver 23 comprises a network interface, an advantageous embodiment of the present invention has been obtained.

According to an embodiment of the present invention, the audio system is controlled via a network. This may be beneficial when the audio system is used in a place, e.g. a home, where a data network exists, and is, e.g., used for enabling listening to music stored on a computer on the same network, watching streaming video via the Internet, etc., or if active loudspeakers and possibly other audio subsystems are connected via data network instead of conventional cabling. The network interface according to the present invention may be any kind of suitable network interface, e.g. for Ethernet, token ring, wireless or any other kind of network technology, communicating by means of any kind of protocol suite, e.g. the TCP/IP protocol suite.

When said auditory perception controlling device 10 is incorporated in a universal remote control, an advantageous embodiment of the present invention has been obtained.

According to an embodiment of the present invention, the auditory perception controlling device forms part of a universal remote control, thereby reducing the number of devices required to control the audio system. Incorporating the auditory perception controlling device in a remote control further enables the two devices to share a common remote control emitter and the auditory perception controlling device may receive remote control commands by wire from the remote control instead of relying on capturing the infrared light signals from the remote control.

The present invention further relates to an audio system 21 comprising audio control settings and at least one remote control receiver 23, wherein an auditory perception controlling device 10 is arranged for automatically adjusting at least a part of said audio control settings via at least one of said at least one remote control receiver 23.

By the present invention is provided an advantageous audio system enabling automatic control of audio control settings via remote control means, thereby, e.g., enabling automatic control of sound established by the audio system, in particular control of the auditory perception of the sound, without requiring specialised audio subsystems or additional signal processing components in the audio signal path. In other words, by the present invention any remote controllable audio system is enabled to have its audio settings controlled automatically in addition to the manual control. The present invention is applicable to any remote controllable audio system, regardless of its value, complexity, location or use, and may thus be used with anything from headsets and mobile audio systems over vehicle audio systems, e.g. in cars or boats, low-cost or HIFI home audio systems and large scale home cinemas and professional audio systems for cinemas, auditoriums, PA-systems, etc.

According to the present invention, audio control settings in an audio system may, e.g., comprise volume or gain settings, bass and treble settings, equalization settings, muting, mono/stereo/surround sound settings, dynamic range control settings, or any other available settings that at least partly, directly or indirectly, control the audio processing and reproduction of sound.

According to the present invention, automatically adjusting audio control settings may comprise any way of controlling the audio control settings without requiring explicit manual interaction for each control command.

According to the present invention, a remote control receiver may be any means of an audio subsystem for receiving audio control settings control commands from outside the audio subsystem itself, e.g. from a remote control communicating by infrared light, ultrasound, radio waves, Bluetooth, microwaves, wireless or wired network, data cables, etc. Typically, the remote control receiver of an audio subsystem according to the invention is a standard infrared remote control receiver.

Hence, an audio system wherein audio control settings are adjusted automatically via the common remote control receiver of the audio system provides an advantageous invention.

When said auditory perception controlling device 10 comprises a processing unit 11 for performing said adjusting at least a part of said audio control settings according to automatic audio control setting adjustment routines, an advantageous embodiment of the present invention has been obtained.

According to the present invention, automatic audio control setting adjustment routines may comprise any routines or algorithms that enable automatic adjustment of audio control settings, e.g. macro-like routines, artificial intelligence like routines, adaptive control routines, etc. Macro-like routines may, e.g., comprise performing one or more predetermined adjustments automatically as a reaction to a predetermined manual input, e.g. performing a volume decrease automatically when the user changes to a specific TV channel, or performing a mute command when a predetermined word is picked up by a microphone. Artificial intelligence like routines and adaptive control routines may, e.g., comprise performing one or more adjustments automatically as a reaction to predetermined or dynamically determined implicit or indirect kinds of input, e.g. time of the day, loudness level measured by microphone, kind of audio content estimated from an audio signal or microphone, background noise determined by means of microphone, etc., or a combination of such inputs.

When said auditory perception controlling device 10 comprises at least one emitter 13, an advantageous embodiment of the present invention has been obtained.

According to a preferred embodiment of the present invention, the auditory perception controlling device is arranged with an emitter for cooperating with the remote control receiver of the audio system.

When said audio control settings control auditory perception of audio established by said audio system 21, an advantageous embodiment of the present invention has been obtained.

According to the present invention, control of auditory perception of audio established by the audio system may comprise control of properties such as, e.g., in particular, loudness, annoyance and intelligibility, but also sharpness, perception intensity, airiness, brilliance, timbre, clarity, presence, liveness, warmth, fullness, spaciousness, etc.

When a predetermined auditory perception of sound established by said audio system 21 is obtained by said adjustment of audio control settings, an advantageous embodiment of the present invention has been obtained.

By providing automatic control of auditory perception properties, e.g. loudness, according to the present invention, e.g. for maintaining a desired loudness when changing TV channel or audio source, reducing the loudness when commercial breaks occur, or improving intelligibility when background noise disturb the perception, the convenience experienced by using such an audio system may be significantly improved.

When said audio system 21 comprises at least one remote controllable audio subsystem 22, an advantageous embodiment of the present invention has been obtained.

According to the present invention, several audio subsystems which together form the audio system may be controlled. Several of the audio subsystems may comprise remote control receivers and audio control settings, and be subject to individual control according to the present invention. The different audio subsystems may be connected to each other, and possibly share a common power amplifier and set of loudspeakers, or they may each comprise individual power amplifiers and loudspeakers or other sound reproduction means. In a typical surround sound HIFI setup, all audio subsystems, e.g. a television set, a DVD-player, a hard disk recorder, a CD-player, an FM radio receiver, etc., shares a common multi-channel power amplifier and a common set of, e.g., 5+1 loudspeakers. A method according to the present invention may control most auditory perception properties, e.g. loudness, merely by controlling the audio control settings of the common power amplifier, but may in more advanced embodiments further control audio control settings of the individual audio subsystems, e.g. in order to achieve an auditory perception not possible with only the audio control settings available in the power amplifier. However, a typical low-cost living room audio system often comprises, to a higher degree, separate, i.e. not connected, audio subsystems, e.g. a television set comprising its own set of built-in loudspeakers and a stereo set, e.g. comprising an FM radio receiver and a CD-player, comprising its own power amplifier and two loudspeakers distributed in the room. In such an audio system, the audio control settings in one audio subsystem does not influence audio reproduced by the other audio subsystem. Thus, to control auditory perception properties, e.g. loudness, an embodiment of the present invention has to control several sets of audio control settings. It is noted that this is a quite straightforward implementation of the present invention, and does not constitute a problem as long as no problem exists regarding manual remote control of the different audio subsets. Only if manual control is problematic, e.g. if the typical several remote control devices interfere with each other, and a command intended for one audio subset causes an unexpected and unintended adjustment in another audio subset, these problems may obviously also exist with an embodiment of the present invention. If, however, such simultaneous adjustments in several audio subsets are intended, an embodiment of the present invention may also be able to handle and exploit such functionality.

When said at least one remote control receiver 23 is a wireless remote control receiver, an advantageous embodiment of the present invention has been obtained.

According to a preferred embodiment of the present invention, the remote control of audio control settings is performed by one or more wireless technologies, e.g. infrared light, ultrasound, radio waves, Bluetooth, microwaves, wireless network, etc.

When said emitter 13 is an infrared emitter and said remote control receiver 23 is an infrared receiver, an advantageous embodiment of the present invention has been obtained.

According to a preferred embodiment of the invention, the remote control of audio control settings is performed by absolutely common infrared remote control technologies applicable to almost any audio system or subsystem available. By providing an audio system where audio control settings are controlled automatically via infrared remote control technology, such audio system may be composed of practically all available audio subsystems.

When said auditory perception controlling device 10 comprises at least one input means 12, 41, 51, 70, an advantageous embodiment of the present invention has been obtained.

According to a preferred embodiment of the present invention, the one or more input means are arranged in the auditory perception controlling device thus providing a self-contained device for performing the automatic adjustments. The input means may comprise any kind of means suitable for manual or automatic input of data, e.g. for configuration purposes, or as a means for observing the occurrence of certain events, e.g. a loudness exceeding a certain level, an audio signal changing kind of content, a background noise being introduced, etc.

When said at least one input means 12, 41, 51, 70 comprises at least one receiver 12, an advantageous embodiment of the present invention has been obtained.

According to a preferred embodiment of the present invention, one input means comprises a remote control receiver enabling automatic control of audio control settings based on what other remote control commands are transmitted to the audio system. When the remote control receiver is arranged in an auditory perception controlling device, that device is enabled to monitor the remote control commands given manually by the users of the audio system, and base the automatic audio control setting adjustment thereon, e.g. by learning typical user behaviour. The receiver should thus preferably be compatible with the remote control technologies and standards used by the conventional manual remote control devices of the audio system.

When said receiver 12 is an infrared light receiver, an advantageous embodiment of the present invention has been obtained.

According to a preferred embodiment of the present invention, the remote control receiver 23 of the audio system enables control by conventional infrared light remote controls. In such an audio system, the receiver 12 of the auditory perception controlling device should also be an infrared light receiver, e.g. in order to be able to pickup remote control commands established by the user, and thereby learn typical user behaviour.

When said at least one input means 12, 41, 51, 70 comprises at least one microphone 41, an advantageous embodiment of the present invention has been obtained.

According to an embodiment of the present invention a microphone is provided for measuring the sound surrounding the auditory perception controlling device. Thereby the automatic audio control settings adjustment routines may be at least partly based on properties and content of the surrounding sound, e.g. by determining the absolute loudness of the sound in the room, the loudness of any background noise, the nature of any background noise, e.g. traffic or machine noise, a conversation, telephone ringing, etc.

When said at least one input means 12, 41, 51, 70 comprises at least one input connector 51, an advantageous embodiment of the present invention has been obtained.

According to an embodiment of the present invention an input connector is provided for receiving an audio signal input, e.g. the currently processed audio from the audio system. The audio signal received may, e.g., be derived from the audio subsystems, from the input of a power amplifier, from the output of a power amplifier, etc. The audio signal is preferably a more or less processed version of the audio currently reproduced by loudspeakers in the room. Thereby the automatic audio control settings adjustment routines may be based on such a signal, e.g. by determining the expected loudness of the audio when reproduced as sound, the kind of content of the audio signal, e.g. commercials, talk show, music, movie, etc. In combination with a microphone input for measuring the surrounding sound as described above, further properties may be determined, e.g. the relative loudness of background noise or a conversation compared to the loudness of sound reproduced by the audio system, whether a detected telephone ring or a conversation is part of the audio signal or present in room together with the sound from the audio system, etc.

When said at least one input means 12, 41, 51, 70 comprises at least one keypad 70, an advantageous embodiment of the present invention has been obtained.

In an embodiment of the present invention, a keypad, a number of buttons or knobs, a touch-sensitive display, or other keypad-like user input means, are provided for allowing direct input from a user. In a preferred embodiment of the present invention, such a feature is provided in addition to other input means as described above, in order to enable configuration, resetting, programming, etc., or overriding automatic adjustments, indicating desired levels or auditory perception, etc.

When said adjusting at least a part of said audio control settings is performed according to automatic audio control setting adjustment routines, an advantageous embodiment of the present invention has been obtained.

According to the present invention, automatic audio control setting adjustment routines may comprise any routines or algorithms that enable automatic adjustment of audio control settings, e.g. macro-like routines, artificial intelligence like routines, adaptive control routines, etc. Macro-like routines may, e.g., comprise performing one or more predetermined adjustments automatically as a reaction to a predetermined manual input, e.g. performing a volume decrease automatically when the user changes to a specific TV channel, or performing a mute command when a predetermined word is picked up by a microphone. Artificial intelligence like routines and adaptive control routines may, e.g., comprise performing one or more adjustments automatically as a reaction to predetermined or dynamically determined implicit or indirect kinds of input, e.g. time of the day, loudness level measured by microphone, kind of audio content estimated from an audio signal or microphone, background noise determined by means of microphone, etc., or a combination of such inputs.

When said adjusting at least a part of said audio control settings is at least partly based on data obtained by monitoring said least one input means 12, 41, 51, 70, an advantageous embodiment of the present invention has been obtained.

According to the present invention, the audio control settings are adjusted automatically, which requires means for determining when, which and how settings should be adjusted. Contrary to an audio system enabling only explicit manual control, the automatically controllable audio system of the present invention may comprise means for monitoring one or more of several possible input means for determining when, which and how audio control settings should be adjusted.

When said adjusting at least a part of said audio control settings is at least partly based on acquired information about at least one user's typical use of said audio system, an advantageous embodiment of the present invention has been obtained.

According to the present invention, information about a user's typical behaviour may preferably be acquired from monitoring remote control commands given manually by the user, e.g. by means of a receiver. By acquiring such information, the automatic control may be based on adaptively or dynamically modified routines based on that information.

When said adjusting at least a part of said audio control settings is at least partly based on predefined routines, an advantageous embodiment of the present invention has been obtained.

According to an embodiment of the present invention, the automatic control is based on predefined routines, e.g. regarding adjustments to perform upon occurrence of events to which most users presumably would react similarly, e.g. reducing loudness when commercial breaks occur, increasing loudness and/or improving intelligibility when background noise exceeds a certain limit, etc. In a preferred embodiment of the present invention, both adaptively or dynamically modified routines, e.g. learned routines, and predefined routines are provided, and an appropriate routine may be selected according to one or more conditions, e.g. regarding the event encountered, the time, whether any behavioural information about that event has previously been gathered or any learned routine exists, etc.

When said adjusting at least a part of said audio control settings is at least partly based on monitoring surrounding sound 42, an advantageous embodiment of the present invention has been obtained.

According to a preferred embodiment of the present invention, surrounding sound is monitored, thereby enabling basing the adjustment routine on information derivable from the surrounding sound. Such information may, e.g., comprise the occurrence of events which may cause an automatic adjustment to be performed, e.g. a telephone that rings, which may cause a mute command to be given automatically, the background noise exceeding a certain limit, which may cause a loudness increase to be performed automatically, a commercial break interrupting, which may cause a loudness reduction to be performed automatically, a predefined word, which may cause a certain routine to be performed, etc. The information derived from the surrounding sound may further comprise additional information to apply when selecting if and which routine to perform upon the occurrence of other events, e.g. for determining exactly how much to modify the loudness when the user changes audio source, exactly how much to reduce the loudness after, e.g., 11 PM, etc.

When said adjusting at least a part of said audio control settings is at least partly based on monitoring the time, an advantageous embodiment of the present invention has been obtained.

According to a preferred embodiment of the present invention, the performance of adjustment routines may be based on the time. This may, e.g., be advantageous for automatically ensuring a loudness decrease at evening and night time, or certain adjustments to be made at predetermined intervals or after a predetermined time of use, etc. The time may also advantageously be associated with learned typical user behaviour routines, as a user may behave differently at different times of the day. For example in an embodiment of the present invention it is learned that when a user listens to radio in the morning, the loudness should be relatively low and when the user watches TV, e.g. music television MTV, in the late afternoon, the loudness should be relatively high.

When said adjusting at least a part of said audio control settings is at least partly based on monitoring an audio signal 52 from said audio system 21, an advantageous embodiment of the present invention has been obtained.

According to an embodiment of the present invention, the audio signal currently processed by the audio system, or a signal derived from it, is provided to the automatic audio control setting adjustment routine for facilitating the decision making. From such an audio signal, e.g., information about the relative loudness or other audio perception properties of the sound reproduced in the room, or information about the content of the audio signal, e.g. commercials, dialog, music, action effects, may be derived. If such an audio signal from the audio system is provided in a system where also a microphone input is available, it is possible to subtract the audio signal from the microphone signal and thereby obtain information about the background noise and distinguish between noise, dialog, spoken commands, etc., originating from the surroundings or users, and the sound established by the audio system. The ability to make such distinctions may be very advantageous in that automatic adjustments may be made on the basis of background noise and other activity, instead of just the general sound present in a room. This may, e.g., be used for automatically reducing loudness when a dialog between users of the audio system is detected, but not if the dialog is part of the audio signal, i.e. originating from the audio system. A further example may comprise increasing loudness and/or improving intelligibility in the case of loud background noise, but not if the noise is part of the audio originating from the audio system.

When said audio system 21 further comprises at least one remote control 24 and said adjusting at least a part of said audio control settings is at least partly based on monitoring remote control signals 14 from said least one remote control 24, an advantageous embodiment of the present invention has been obtained.

In a preferred embodiment of the present invention, the automatic adjustment is based on the monitoring of remote control commands from one or more remote controls of the audio system. This feature enables learning typical user behaviour and subsequently start performing such behaviour automatically, thus substituting manual control. The feature may also be used for performing predefined adjustments when certain remote control commands are detected, in a macro-like fashion. Hence, simple commands of a common, manual remote control may be used for controlling the performance of advanced, possibly multiple, commands and adjustments according to the present invention, possibly on the basis of the current state of other input means, e.g. the present sound as monitored by a microphone, the current audio as monitored by an input connector, the current time, etc.

When said monitoring surrounding sound 42 comprises using said microphone 41 for measuring sound, an advantageous embodiment of the present invention has been obtained.

In a preferred embodiment of the present invention, the surrounding sound is measured by means of a microphone.

When said adjusting at least a part of said audio control settings is at least partly based on monitoring user input via user input means 70, an advantageous embodiment of the present invention has been obtained.

In an embodiment of the present invention, a keypad, a number of buttons or knobs, a touch-sensitive display, or other user input means, is provided for allowing direct input from a user. In a preferred embodiment of the present invention, such a feature is provided in addition to other input means as described above, in order to enable configuration, resetting, programming, etc., or overriding automatic adjustments, indicating desired levels or the desired auditory perception, etc.

When said audio system 21 comprises at least one remote control 24 and said auditory perception controlling device 10 comprises a receiver 12, a processing unit 11 and an emitter 13, wherein said receiver 12 is arranged to cooperate with said at least one remote control 24, said emitter 13 is arranged to cooperate with said remote control receiver 23, and said processing unit 11 is arranged to learn at least one behaviour of at least one user of said audio system at least partly from data obtained by said receiver 12, to associate each of said at least one behaviour with at least one condition, to monitor fulfilment of said at least one condition, and upon fulfilment of at least one of said at least one condition to automatically repeat said associated behaviour at least partly by means of said emitter 13, wherein said repeating said associated behaviour comprises performing adjustment of said audio control settings in said audio system 21 via said remote control receiver 23, an advantageous embodiment of the present invention has been obtained.

According to the present invention, a behaviour of a user comprises, e.g., audio control setting adjustments typically performed by a user under certain conditions, e.g. that a user typically increases volume for certain TV channels, typically decreases volume when commercial breaks occur, typically increases bass boost when listening to music, typically enables surround sound when watching DVD's, typically configures the equalizer to a speech enhancing setting when listening to a radio talk show while the cooker hood is active, typically mutes the audio system when the phone rings, typically enables dynamic range compression and reduces volume when watching action movies at evening due to the neighbours, typically reduces volume when having a conversation in the room, etc.

According to the present invention, conditions associated with a behaviour may comprise one or more conditions regarding data received from any kind of input means, e.g. a remote control receiver, a microphone, an audio signal, a timer or a watch, a keypad or similar, etc. Conditions may, e.g., comprise a certain remote control command, e.g. change of channel or audio source, a certain background noise level, a certain general loudness, a certain content of the audio, e.g. commercials, a certain content of other sounds in the room, e.g. conversation, phone ring, etc.

By an embodiment of the present invention is provided an advantageous method of learning typical user behaviour and, by time, taking over such behaviour and automatically performing the adjustments until then performed manually by the user, thereby leaving to the user only to choose the channel or audio source, and not care about the related typically necessary adjustments.

When said auditory perception controlling device 10 comprises a microphone 41, a processing unit 11 and an emitter 13, wherein said microphone 41 is arranged to measure surrounding sound 42, said emitter 13 is arranged to cooperate with said remote control receiver 23, and said processing unit 11 is arranged to automatically perform adjustment of said audio control settings in said audio system 21 via said remote control receiver 23 upon said surrounding sound 42 fulfilling predefined or user defined conditions, an advantageous embodiment of the present invention has been obtained.

Thereby is provided an audio system that enables automatically performing adjustments according to the user's predefined wishes, or wishes presumed by the manufacturer, under certain conditions regarding the present sound. In a preferred embodiment of the present invention, the conditions may be defined manually or they may be learned from monitoring typical user behaviour.

When said auditory perception controlling device 10 comprises an input connector 51, a processing unit 11 and an emitter 13, wherein said input connector 51 is arranged to receive an audio signal 52 from said audio system 21, said emitter 13 is arranged to cooperate with said remote control receiver 23, and said processing unit 11 is arranged to automatically perform adjustment of said audio control settings in said audio system 21 via said remote control receiver 23 upon said audio signal 52 fulfilling predefined or user defined conditions, an advantageous embodiment of the present invention has been obtained.

Thereby is provided an audio system that enables automatically performing adjustments according to the user's predefined wishes, or wishes presumed by the manufacturer, under certain conditions regarding the audio currently processed by the audio system. In a preferred embodiment of the present invention, the conditions may be defined manually or they may be learned from monitoring typical user behaviour.

When said auditory perception controlling device 10 is arranged to continuously monitor fulfilment of one or more conditions regarding remote control signals, surrounding sound, audio signals from said audio system, time and/or user input and upon fulfilment automatically perform said adjustment of audio control settings in said audio system 21, an advantageous embodiment of the present invention has been obtained.

Thereby is provided an audio system that enables automatically performing adjustments when certain conditions are fulfilled, thereby taking over what is normally left to the user to do manually.

When said controlling auditory perception comprises controlling the loudness of sound established by said audio system 21, an advantageous embodiment of the present invention has been obtained.

According to a preferred embodiment of the present invention, auditory perception properties, and in particular loudness, is controlled automatically.

When said controlling auditory perception comprises controlling the intelligibility of sound established by said audio system 21, an advantageous embodiment of the present invention has been obtained.

When said controlling auditory perception comprises controlling the annoyance of sound established by said audio system 21, an advantageous embodiment of the present invention has been obtained.

When said audio control settings comprise gain settings, an advantageous embodiment of the present invention has been obtained.

When said audio control settings comprise bass and treble settings, an advantageous embodiment of the present invention has been obtained.

When said audio control settings comprise equalization settings, an advantageous embodiment of the present invention has been obtained.

When said audio control settings comprise mute settings, an advantageous embodiment of the present invention has been obtained.

When said audio control settings comprise mono, stereo and surround sound settings, an advantageous embodiment of the present invention has been obtained.

When said audio control settings comprise dynamic range control settings, an advantageous embodiment of the present invention has been obtained.

When said auditory perception controlling device 10 comprises a network interface, an advantageous embodiment of the present invention has been obtained.

According to an embodiment of the present invention, the auditory perception controlling device is network enabled, thereby being able to, e.g., receive firmware or configuration updates or transmitting status or other information via a network, e.g. the Internet. The network interface may further be used to, e.g., control an audio subsystem and receive information from an audio subsystem, etc.

When said emitter 13 and said remote control receiver 23 comprise network interfaces, an advantageous embodiment of the present invention has been obtained.

According to an embodiment of the present invention, the audio system is controlled via a network. This may be beneficial when the audio system is used in a place, e.g. a home, where a data network exists, and is, e.g., used for enabling listening to music stored on a computer on the same network, watching streaming video via the Internet, etc., or if active loudspeakers and possibly other audio subsystems are connected via data network instead of conventional cabling. The network interface according to the present invention may be any kind of suitable network interface, e.g. for Ethernet, token ring, wireless or any other kind of network technology, communicating by means of any kind of protocol suite, e.g. the TCP/IP protocol suite.

When said auditory perception controlling device 10 is incorporated in a universal remote control, an advantageous embodiment of the present invention has been obtained.

According to an embodiment of the present invention, the auditory perception controlling device forms part of a universal remote control, thereby reducing the number of devices required to control the audio system. Incorporating the auditory perception controlling device in a remote control further enables the two devices to share a common remote control emitter and the auditory perception controlling device may receive remote control commands by wire or any other means from the remote control instead of relying on capturing the infrared light signals from the remote control.

The present invention further relates to an auditory perception controlling device 10 comprising at least one input means 12, 41, 51, a processing unit 11 and an emitter 13, wherein said processing unit 11 cooperates with said emitter 13 to establish remote control signals 15 upon fulfilment of predefined, user defined or dynamically determined conditions regarding data received by at least one of said at least one input means 12, 41, 51, wherein at least one of said at least one input means 12, 41, 51 is selected from a group consisting of a receiver 12 for receiving remote control signals 14, a microphone 41 for measuring surrounding sound 42 and an input connector 51 for receiving an audio signal 52.

According to the present invention, an advantageous device for automatically establishing remote control commands upon fulfilment of certain predefined or adaptively defined conditions is provided. The establishment of remote control commands may be autonomous and triggered by events such as background noise level, loudness level, commercial break presence, etc., occurring around the auditory perception controlling device, and/or it may be learned from monitoring user behaviour and triggered by events such as change of channel or audio source, change of type of content of the audio, e.g. music or talk show, time of the day, etc.

When said remote control signals 15 comprises auditory perception controlling command signals 15 suitable for adjusting audio control settings of an audio system 21, an advantageous embodiment of the present invention has been obtained.

According to a preferred embodiment of the present invention, the remote control signals comply to conventional remote control signal standards, and may thus be used for adjusting audio control settings of audio systems, and thereby control the auditory perception of sound reproduced by such audio systems.

When said remote control signals 15 are established according to automatic audio control setting adjustment routines, an advantageous embodiment of the present invention has been obtained.

According to the present invention, automatic audio control setting adjustment routines may comprise any routines or algorithms that enable automatic adjustment of audio control settings, e.g. macro-like routines, artificial intelligence like routines, adaptive control routines, etc. Macro-like routines may, e.g., comprise performing one or more predetermined adjustments automatically as a reaction to a predetermined manual input, e.g. performing a volume decrease automatically when the user changes to a specific TV channel, or performing a mute command when a predetermined word is picked up by a microphone. Artificial intelligence like routines and adaptive control routines may, e.g., comprise performing one or more adjustments automatically as a reaction to predetermined or dynamically determined implicit or indirect kinds of input, e.g. time of the day, loudness level measured by microphone, kind of audio content estimated from an audio signal or microphone, background noise determined by means of microphone, etc., or a combination of such inputs.

When said auditory perception controlling device comprises a time tracking means and said conditions at least partly regard the time as provided by said time tracking means, an advantageous embodiment of the present invention has been obtained.

When said auditory perception controlling device comprises a universal remote control, an advantageous embodiment of the present invention has been obtained.

According to an embodiment of the present invention, the auditory perception controlling device forms part of or comprises a universal remote control, thereby reducing the number of devices required to control the audio system. Incorporating the auditory perception controlling device in a remote control further enables the two devices to share a common remote control emitter and the auditory perception controlling device may receive remote control commands by wire or any other means from the remote control instead of relying on capturing the infrared light signals from the remote control.

When said auditory perception controlling device comprises network interface means, an advantageous embodiment of the present invention has been obtained.

Thereby is obtained an embodiment of the present invention enabling firmware updates and/or configuration to be performed from other network units, e.g. a personal computer, e.g. via the Internet or a local area network LAN. The network interface further enables status and other information to be transmitted to other network devices, and control information to be received by or transmitted from the auditory perception controlling device.

### BRIEF DESCRIPTION OF THE DRAWINGS

In the following, the invention will be described with reference to the drawings where

FIG. 1 illustrates an embodiment of the present invention,

FIG. 2 illustrates an example of a practical use of an embodiment in an audio system,

FIG. 3 illustrates a block diagram of an embodiment of the present invention,

FIG. 4 illustrates an embodiment comprising a receiver and a microphone,

FIG. 5 illustrates an embodiment comprising a receiver and an input connector,

FIG. 6 illustrates an embodiment combining the embodiments of FIGS. 4 and 5,

FIG. 7 illustrates an embodiment incorporated in a remote control device,

FIG. 8 illustrates an example of a practical use of an embodiment in an audio system,

FIG. 9A illustrates an embodiment comprising a microphone,

FIG. 9B illustrates an embodiment comprising an input connector, and

FIG. 9C illustrates an embodiment combining the embodiments of FIGS. 9A and 9B.

### DETAILED DESCRIPTION

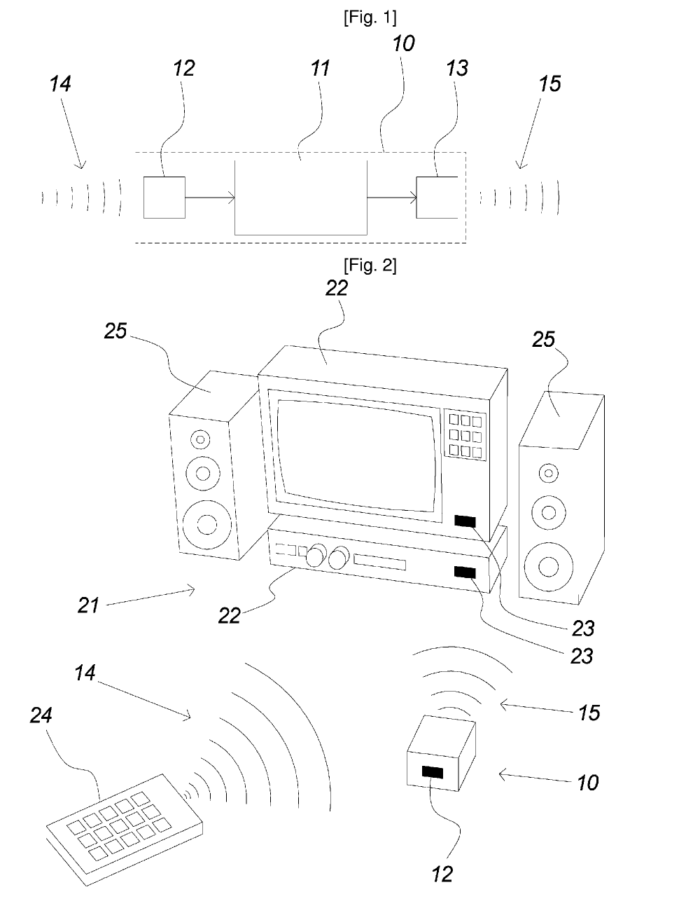

FIG. 1 illustrates a minimal configuration of an auditory perception controlling device 10 according to an embodiment of the present invention. It comprises a processing unit 11, a receiver 12 for receiving remote control command signals 14 and an emitter 13 for emitting auditory perception controlling command signals 15.

FIG. 2 illustrates an example of a practical set-up including an auditory perception controlling device 10 according to an embodiment of the present invention. It comprises an audio system 21 which may typically be found in any home, in this example consisting of a couple of remote controllable audio subsystems 22, e.g. a television and a stereo amplifier with built-in radio receiver, and a couple of loudspeakers 25. The audio subsystems 22 each comprise a remote control receiver 23 and the set further comprises at least one remote control 24. Significant parameters, such as volume, audio source, TV- or radio channel, etc., of the audio system 21 may be controlled by means of the remote control 24 by emission of remote control command signals 14. The audio system may comprise any audio subsystems such as television sets, radios, CD- or DVD-players or recorders, video or audio tape players or recorders, personal computers provided with audio output, streaming media receivers, vehicle audio systems with remote control option, e.g. in cars or boats, etc. The loudspeakers may comprise any loudspeaker setup or other sound rendering means, such as headphones. The individual audio subsystems components are preferably controlled by a single remote control based on infrared command signals, but may as well be controlled by several remote controls, e.g. one remote control per subsystem, and based on any remote control technology, e.g. ultrasound, etc. The audio system 21 may, in an alternative embodiment, be a single, self-contained unit comprising audio subsystems for processing audio and loudspeakers for reproducing sound, such as, e.g., a portable transistor radio or ghetto blaster.

During the use of an audio system as described above, the auditory perception experienced by a listener, e.g. loudness, i.e. the sound intensity perceived by the listener, annoyance, i.e. how disturbing the sound is according to the listener, intelligibility, i.e. how well the listener understands, e.g., speech, etc., typically varies as the listener switches between different audio subsystems, i.e. sources, or channels, e.g. television channels. This behaviour typically causes the listener to, e.g., turn the volume up or down and change equalization settings almost every time he switches source or channel, in order to maintain a fairly constant auditory perception, e.g. regarding loudness, according to his preferences, or in order to adapt the auditory perception, e.g. regarding intelligibility, according to the current program type, time, environmental disturbance, etc.

FIG. 2 further comprises an auditory perception controlling device 10 according to an embodiment of the present invention. The auditory perception controlling device 10 comprises a receiver 12 for receiving remote control command signals 14 and an emitter 13, not shown in FIG. 2, for emitting auditory perception controlling command signals 15. The auditory perception controlling device 10, as well as the remote controllable audio subsystems 22, thus receives the remote control command signals 14. And the remote controllable audio subsystems 22 receive the remote control command signals 14 from the remote control 24, as well as auditory perception controlling command signals 15 from the auditory perception controlling device 10.

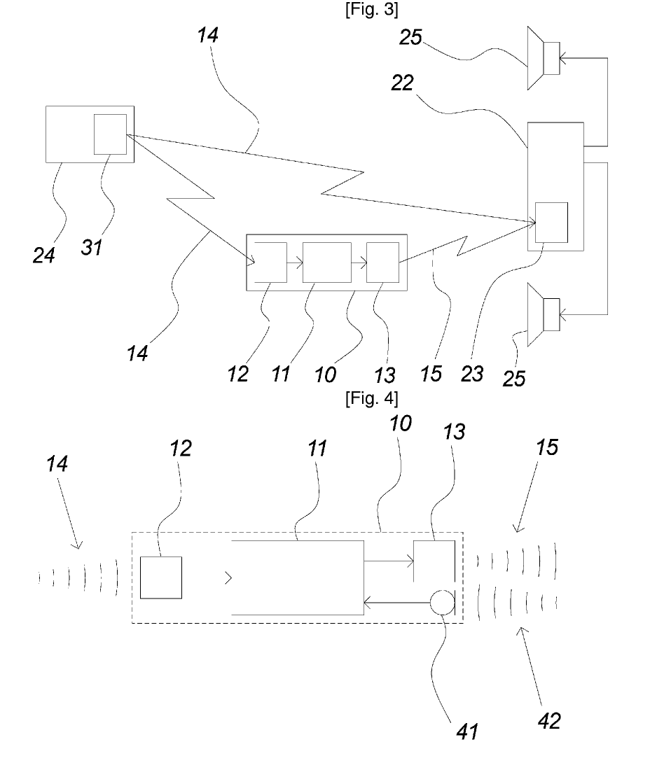

FIG. 3 illustrates the set-up of FIG. 2 by means of a block diagram. It comprises remote controllable audio subsystems 22, e.g. a television and a stereo amplifier with built-in radio receiver and a couple of loudspeakers 25. The audio subsystems 22 comprise remote control receivers 23 and the set further comprises at least one remote control 24. The remote control 24 may control significant parameters of the remote controllable audio subsystems 22 by emission of remote control command signals 14 from an emitter 31. FIG. 3 further comprises an auditory perception controlling device 10 according to an embodiment of the present invention. The auditory perception controlling device 10 comprises a receiver 12 for receiving remote control command signals 14 and an emitter 13 for emitting auditory perception controlling command signals 15. The auditory perception controlling device 10, as well as the remote controllable audio subsystems 22, thus receives the remote control command signals 14. And the remote controllable audio subsystems 22 receive the remote control command signals 14 from the remote control 24, as well as auditory perception controlling command signals 15 from the auditory perception controlling device 10.

The auditory perception controlling device 10 is, in a preferred embodiment, a separate device not linked to any of part of the audio system by means other than remote control signals, preferably infrared signals. In an alternative embodiment, the auditory perception controlling device is incorporated in a common universal remote control. In a preferred embodiment, the auditory perception controlling device is battery-powered, but may alternatively be powered by an AC/DC-adapter or any other suitable means. It is preferably placed somewhere between the listening position from where the remote control 24 is usually operated and the remote controllable audio subsystems 22, but as most remote controls emit very wide fields of remote control command signals 14 and usually work even though pointing in directions not near the direction of the remote controllable audio subsystems 22, the auditory perception controlling device 10 may typically also be able to pick up the remote control command signals 14 from the remote control 24 even when positioned to the side of the direct line of sight. This facilitates positioning the auditory perception controlling device 10 according to convenience and aesthetics as well as functionality. The auditory perception controlling device 10 should, however, be positioned so that the auditory perception controlling command signals 15 are also picked up by the remote control receivers 23 of the remote controllable audio subsystems 22. The auditory perception controlling device may be placed, e.g., on a coffee table, on a shelf under a coffee table, on the floor, on the ceiling, on nearby bookshelves, etc.

The processing unit 11 of the auditory perception controlling device 10 may be any kind of processing means, e.g. a digital signal processor DSP, a central processing unit CPU, other kinds of microprocessors, programmable gate arrays, etc., or it may be formed by discrete logic components and/or analog components. The processing unit 11 preferably comprises storing means or at least has access to storing means, e.g. RAM, flash memory, etc. The auditory perception controlling device 10 may preferably comprise a backup battery for preserving the information stored in memory while the batteries are changed, or the memory may be of a type that preserves its contents even when not powered.

Whenever the remote control 24 is used for controlling the remote controllable audio subsystems 22, the remote control command signals 14 are also received by the auditory perception controlling device 10 and processed by the processing unit 11. This enables the auditory perception controlling device 10 to learn typical uses of the remote control over time. In a preferred embodiment, the processing unit 11 is able to recognize at least the remote control commands for volume increase and decrease, and selection of sound sources and channels. If, for example, the listener typically increases volume after selecting the radio receiver as sound source, the auditory perception controlling device will learn this usual behaviour when having recognized it several times and then store it for future reference. Likewise, if, for example, the listener typically decreases volume after switching to a particular channel on the television, the auditory perception controlling device will learn this usual behaviour when having recognised it several times and then store it for future reference. Hence, the auditory perception controlling device will learn the amount of volume increase or decrease typically associated with particular channel or sound source changes over time. As the auditory perception controlling device 10 itself is equipped with an emitter 13, it will, over time, be able to emit auditory perception controlling command signals simulating the usual behaviour of the listener, e.g. certain amounts of volume increase or decrease, directly to the remote controllable audio subsystems 22 without any listener interaction. Hence, after a while, the listener may stop using the volume buttons after source or channel switches, and let the auditory perception controlling device adjust the volume according to the listener's prior behaviour. The auditory perception controlling device 10 may thus be seen as a kind of remote, universal automatic gain control, which needs not be embedded into the audio subsystems, and which may operate any remote controllable audio subsystem. In a preferred embodiment, the auditory perception controlling device continues to recognize any manual settings made by the listener even though certain behaviour already has been learned. Thereby, the auditory perception controlling device is able to adapt and improve its simulation and automatic control, also if the listener completely changes his listening preferences, or adapts the audio system, e.g. by replacing the loudspeakers or the television set, adding a DVD-player, etc. In a further, preferred embodiment, the processing unit 11 is able to recognise further remote control commands, e.g. the commands for bass and treble settings, equalization settings, muting, mono/stereo/surround sound settings, dynamic range control, etc., and thereby be able to control more auditory perception properties than merely loudness, e.g. properties such as annoyance, intelligibility, sharpness, perception intensity, airiness, brilliance, timbre, clarity, presence, liveness, warmth, fullness, spaciousness, etc.

The auditory perception controlling device 10 should be adapted to recognize and emit the remote control commands used by the particular audio subsystems. Such commands are typically specific for audio system brands and even for some audio system models. Several methods of adapting a universal remote control to a specific set of remote control commands are, however, known from universal remote controls.

One method comprises pre-defining which audio system brands or model each universal remote control should be usable with, and then storing the corresponding command table in the remote controls. A second method comprises storing several different remote control command tables corresponding to several specific brands and/or system models in the universal remote control, and enabling the user to choose the command table that corresponds to his particular audio system by entering a code. A third method comprises providing a universal remote control with a receiver as well as an emitter, and then teaching it the commands corresponding to the particular audio system by emitting them from the system-specific remote control towards the universal remote control, typically according to a pre-defined sequence. Further methods and combinations are well known in the art of remote controls, and any of the methods may be used with an auditory perception controlling device 10 according to the present invention in order to enable the auditory perception controlling device to be used with a particular audio system. In the case where more than one remote control is used for controlling different remote controllable audio subsystems, the auditory perception controlling device may be able to learn and associate several command signals to one command, and also be able to emit a suitable one of several command signals for controlling a particular component of the audio system. In a typical home environment, the listener, however, uses a common output amplifier for controlling the loudspeakers, and it may thus be sufficient if the auditory perception controlling device is able to control that amplifier.

In a typical embodiment, the auditory perception controlling device 10 does not comprise any information regarding the audio system or the listener's behaviour, except maybe for the correct remote control command table, when it is first used. As for example different television sets increase the volume by different amounts per press on the volume increment button, the auditory perception controlling device does not know how much a single volume increment control command may affect the loudness experienced by the listener. This is, however, not a problem as the auditory perception controlling device learns from the listener's own use of the remote control how many presses are suitable.

In more advanced embodiments, the auditory perception controlling device may also store further characteristics about the listener's behaviours in order to provide more accurate automatic control. Such further characteristics may, e.g. comprise different auditory perception properties controlling parameter settings, e.g. regarding loudness at different times of the day, different settings when zapping, i.e. quickly changing source or channel several times, etc.

By recognizing the time of the day together with the use of the volume buttons and source/channel selectors, and preferably further buttons such as bass/treble, etc., the auditory perception controlling device may be able to learn that the listener may have different desires regarding auditory perception overall, or of, e.g., a certain television channel, at different times of the day. It is noted that such functionality does not require a watch of the auditory perception controlling device to be properly set, and set again from time to time, e.g. in connection with daylight-saving time. Associating the time of the day with the other observations merely requires the auditory perception controlling device to be able to recognize time differences, which is possible with almost any processor suitable as processing unit 11. In an advanced embodiment of the present invention, the auditory perception controlling device may however also be equipped with a regular watch set to the actual time of the day and, e.g., a display for showing the time and possibly also other information such as, e.g., the last automatic adjustment made, a reference to the currently performed behaviour, etc.

By recognizing the listener's several quick changes of source and/or channel as zapping, the auditory perception controlling device may be able to decrease the volume further during the zapping, in order to decrease, e.g., loudness, annoyance, etc. While not necessarily part of a behaviour learnt from observing the listener, a loudness decrease while zapping may actually be desirable for many listeners, and is thus an example of a feature extending the basic listener behaviour simulation part of the auditory perception controlling device according to the present invention.

The auditory perception controlling device 10 may furthermore comprise a switch for turning it on or off, or enabling and disabling it, a reset switch for deleting stored observations or behaviours, a switch for changing between learning mode and active mode, a switch or buttons for changing between different listening modes, a switch or buttons for providing user input, e.g. the current time, one or more status light emitting diodes or displays or other visual information means, etc. It is noted that, in a preferred embodiment, the listener does not have to select when the auditory perception controlling device should be in learning mode or active mode, but such a switch may provide an advantageous option of forcing the auditory perception controlling device to learn, e.g., a new behaviour. In an advantageous embodiment, the auditory perception controlling device enables the listener to select between different listening modes for choosing different auditory perception preferences for different situations. Such listening modes may, e.g., comprise normal, zapping, movie, background music, talk show, soft, etc. In a preferred embodiment, the auditory perception controlling device stores the listener's behaviour in the normal mode, and have pre-defined offsets from the normal mode stored in the other modes. In a further preferred embodiment, the auditory perception controlling device may change such offsets according to the listener's behaviour while being in the listening modes other than the normal mode.

In a further preferred embodiment, the auditory perception controlling device 10 may furthermore provide several setting profiles to choose from. Thereby each person using the audio system may have his or her own settings assigned to a personal profile. The profiles may be selected by an input means such as a button or knob, by remote control, by a predefined remote control command sequence, by voice recognition or any other suitable means. Further profiles may be provided for common use, when, e.g., a family, i.e. several persons, is watching a movie together, the audio system is used for background entertainment, etc.

FIG. 4 illustrates an enhanced embodiment of an auditory perception controlling device according to an embodiment of the present invention. It comprises an auditory perception controlling device 10 comprising a processing unit 11, a receiver 12 for receiving remote control command signals 14, an emitter 13 for emitting auditory perception controlling command signals 15, and a microphone 41 for measuring sound 42 surrounding the auditory perception controlling device. The microphone may be any kind of transducer for converting sound energy into electrical energy or digital information, e.g. any kind of microphone or other suitable component. When furnished with a microphone 41, the processing unit 11 of the auditory perception controlling device 10 must also be provided with circuitry and/or instructions for processing the information obtained by the microphone. Such processing may, e.g., comprise measuring the absolute sound level, which is closely related to the loudness level, in the room, estimating the kind of audio signal in order to improve, e.g., intelligibility of speech and dialogue and decrease, e.g., annoyance of commercial breaks, measuring the loudness increase corresponding to one press on the volume button, etc.

The microphone-equipped auditory perception controlling device of FIG. 4 may provide more accurate auditory perception control, as well as featuring further uses of the auditory perception controlling device. By providing the device with a microphone, an acoustic feedback has been provided, facilitating different kinds of adaptive control. For example, the auditory perception controlling device may learn which, e.g., loudness levels the listener prefers instead of learning the exact number of volume button presses. Thereby, the auditory perception controlling device may control, e.g., the loudness by adjusting the volume and continuously measure the loudness caused by the volume changes. Because of the acoustic feedback, and thereby this method being adaptive, the auditory perception controlling device is able to ensure a desired loudness more accurately. Moreover, the auditory perception controlling device may track loudness changes, e.g. when commercial breaks occur during a movie watched on the television set, and automatically maintain the desired loudness, or even attenuate further for obtaining an annoyance reduction. In a further advanced embodiment, the desired auditory perception, e.g. regarding loudness, is also associated with the time of the day, in order to possibly maintain different auditory perception at different day times.

Besides facilitating acoustic feedback for improved control, the microphone 41 also enables the processing unit 11 to estimate the kind of audio currently listened to. The processing unit may be able to distinguish between, e.g., music, speak, sports, commercials, etc., and thereby facilitate associating different desired auditory perception, e.g. loudness levels with different kinds of audio as well as, if desirable, the time of the day.

The processing unit may also be able to distinguish the characteristic sound of the listener's telephone ringing, and thereby facilitate muting the audio system when the telephone rings. Furthermore, the processing unit may be enabled to detect voice commands from the listener. Such commands may, e.g., be mapped to different typical remote control commands, such as, e.g., mute, volume change, channel change, source change, etc., and/or they may be mapped to different controls of the auditory perception controlling device itself, e.g. standby, change listening mode, store current settings, e.g., loudness level as preferred level, etc. The voice commands should be programmed by the listener in order to enable the auditory perception controlling device to detect his voice and the way he pronounces the voice commands—and not react to e.g. something said in the program played by the audio system.

By also using the microphone input to measure the relationship more accurately between one press of the volume up or down buttons and the actual loudness increase or decrease caused thereby, a more accurate loudness control, i.e. by feedback control, is facilitated.

A further advantage obtained by implementing the microphone 41 is the possibility of performing a kind of audio compression as also known from, e.g., DVD-players. This kind of audio compression is used when, e.g., watching action movies, listening to classical music, or watching or listening to other media where the sound is sometimes faint and sometimes very loud, i.e. has a broad dynamic range. If the volume is increased in order to be able to hear the faint sounds, the loud sounds may become louder than desired, or at least loud enough to disturb the neighbours at night. The present kind of audio compression is, e.g. in some DVD-players, applied at the output stage, and simply limits or attenuates signal levels beyond a predefined threshold. The attenuation is thus determined on the basis of the signal level. As the processing unit 11 of an embodiment of an auditory perception controlling device 10 according to the present invention is able to measure the current loudness level on the basis of the microphone input, it is also able to decrease the volume by means of control commands when the estimated loudness level exceeds a predetermined loudness level, and thus limiting the audio level. The limiting may be hard, i.e. simply not allowing the loudness level to exceed a predetermined loudness level, or it may be a compression where the attenuation depends on the loudness level, e.g. according to a linear or logarithmic response. When, e.g., an action scene is finished and the sound returns to normal or faint, the auditory perception controlling device may detect the loudness level decreasing, and then increase the volume. Evidently the auditory perception controlling device is not able to control the loudness fast enough to unrecognizably compress every loud sound. This is, e.g., because the auditory perception controlling device only measures the sound in the room at the same time as the listener hears it, and because audio systems typically react rather slow to volume decrease commands, compared to the quickness of a sudden loudness increase, e.g. during a movie. As the auditory perception controlling device of the present embodiment is not able to perform compression on a sample-to-sample (or period-to-period) basis on the audio signal before the loudspeakers render the sound, it may instead implement a compression based on the average loudness level within a longer time-frame, e.g. 1, 5 or 10 seconds, and also use, e.g., 1, 5 or 10 seconds to perform the appropriate volume adjustment. Thereby the auditory perception controlling device resembles the typical listener's behaviour better when exposed to undesirable loud sounds, i.e. first use a small time to evaluate if volume adjustments are necessary, and then use the relatively slow remote control method to perform global adjustments that are maintained and only evaluated at certain intervals. As mentioned above, the auditory perception controlling device may implement hard limiting or a less recognizable compression function, and in both cases hysteresis may be incorporated to avoid constantly changing the volume.

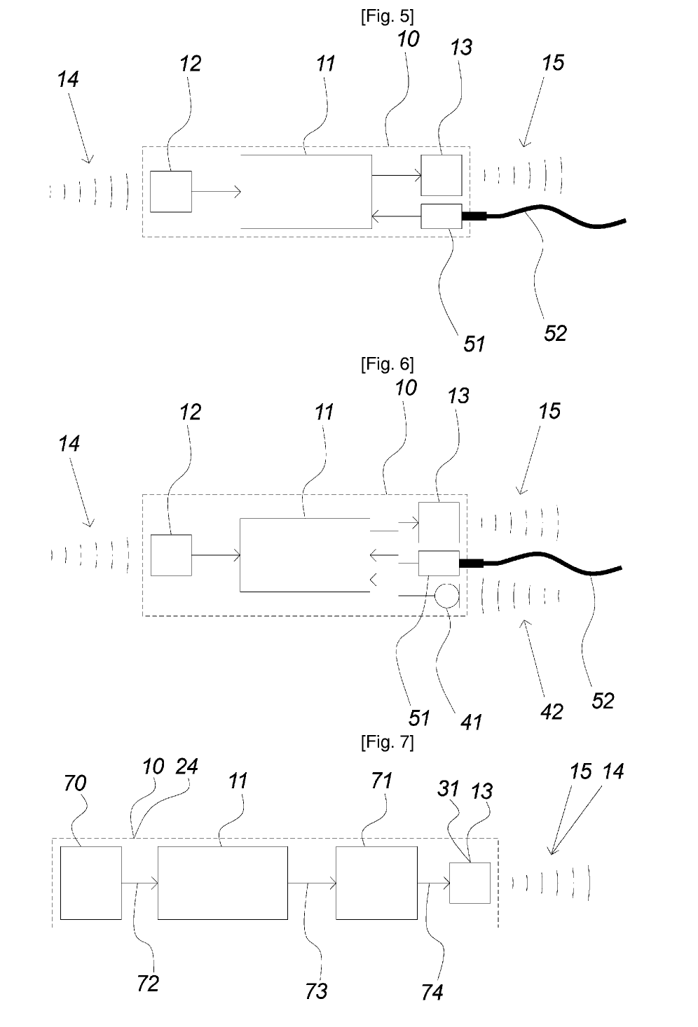

FIG. 5 illustrates an enhanced embodiment of an auditory perception controlling device according to an embodiment of the present invention. It comprises an auditory perception controlling device 10 comprising a processing unit 11, a receiver 12 for receiving remote control command signals 14, an emitter 13 for emitting auditory perception controlling command signals 15, and an input connector 51 for receiving an audio signal connection 52. The input connector 51 and connection 52 should correspond to each other, but may be any means for enabling reception of an audio signal for use in the processing unit 11. The input connector 51 is preferably a socket for a common audio plug type, e.g. a jack plug, phono plug, etc., but may be any suitable connector type, e.g. optical fibre connector, BNC plug, RJ-45 plug, a radio frequency receiver, microwave receiver, wireless LAN device, infrared receiver, etc. The connection 52 may comprise any suitable kind of wire, optical fibre or wireless connection. When furnished with an input connector 51, the processing unit 11 of the auditory perception controlling device 10 must also be provided with circuitry and/or instructions for processing the information obtained by the input connector. Such processing may, e.g., comprise estimating the relative sound level in the room, i.e. the relative loudness, estimating the kind of audio signal, measuring the loudness increase corresponding to one press on the volume button, etc.

The connection 52 establishes a connection from a, typically electrical, representation of an audio signal somewhere within the audio system to the input connector 51 of the auditory perception controlling device 10. This provides the device to obtain information about the audio signal.

In a preferred embodiment, the audio signal connected with the auditory perception controlling device is the same signal that is also rendered by the loudspeakers, i.e. the audio signal subsequent to all processing within the audio system, except the loudspeaker rendering. Such signal is in the following referred to as a processed signal, and may typically be picked up from, e.g., a headphone output, an “audio out” plug, etc. Actually, such processed signal may have been attenuated compared to the power signal sent to the loudspeakers, but such attenuation may typically be represented simply by constant factor. Alternatively, the signal may be picked up directly from the connection to one or more loudspeakers. The important aspect is that the signal level is substantially directly proportional to the signal level provided to the loudspeakers, and thus the loudness level experienced by the listener, if no other sound sources influence.

In an alternative embodiment, the audio signal connected with the auditory perception controlling device is picked up prior to any filtering and level processing, and may thus not be directly proportional to the sound rendered by the loudspeakers. In the following, such signal is referred to as an unprocessed signal, even though it obviously has been processed in steps however irrelevant to the present invention, and in an audio system where several audio subsystems share a single power amplifier and set of loudspeakers, the unprocessed signal may, e.g., be picked up from the individual audio subsystems instead of from the power amplifier. Such unprocessed signal may typically be picked up from, e.g., a headphone output, an “audio out” plug, etc., of the individual audio subsystems, or the same plug that establishes the connection to the power amplifier.

In audio systems where the processed or unprocessed audio signal is a multi-channel signal, e.g. stereo, surround sound, etc., the signal connected to the auditory perception controlling device may comprise just one of the channels, e.g. one of the front channels or a mix of two or more channels, or the auditory perception controlling device may be provided with a corresponding number of input connectors 51 and the processing unit 11 with logic for handling multiple channels, either by merely mixing them, or by processing them individually.

In a preferred embodiment where the processed audio signal representation is provided to the auditory perception controlling device of the present invention, the device may provide almost the same features as when a microphone is provided, as described above with reference to FIG. 4. It is not possible to measure the absolute loudness level experienced by the user, but as the processed audio signal is closely related to the loudness level, a relative loudness level may be estimated. As with the microphone-equipped embodiment, it is possible to improve the loudness control with a feedback, electrical instead of acoustic, for facilitating adaptive control and thereby avoiding only relying on the behaviour learned from the listener.

The processed audio signal input may also be used to measure more accurately the relationship between one press of the volume up or down buttons and the relative loudness increase or decrease caused thereby, and thus provide a more accurate loudness control, i.e. by the use of feedback.

In an alternative embodiment where the unprocessed audio signal representation is provided to the auditory perception controlling device of the present invention, the device is not able to provide all features of the embodiments with microphone or access to the processed signal. Hence, neither the absolute or relative loudness level can be measured without further knowledge about the particular audio system configuration.

However, several of the features described above with regard to the microphone-equipped embodiment may also be implemented in embodiments where the processed or unprocessed audio signal is received. On the basis of either the processed or unprocessed audio signal, it is possible to track loudness changes, e.g. when commercial breaks occur during a movie watched on the television set, and automatically maintain the desired loudness. In a further advanced embodiment, the desired loudness is also associated with the time of the day, in order to possibly maintain different overall loudness levels at different day times. Moreover both kinds of signals may be used for estimating the kind of audio currently listened to. The processing unit may be able to distinguish between, e.g., music, speak, sports, commercials, etc., and thereby facilitate the process of associating different desired loudness levels or other auditory perception properties with different kinds of audio, as well as, if desirable, the time of the day. Moreover, both kinds of signals may be used for implementing the kind of audio compression described above.

In neither processed nor unprocessed signal embodiments of the auditory perception controlling device is it possible to facilitate the features comprising recognition of sounds not originating from the audio system, e.g. telephone ringing or voice commands, without further components.

FIG. 6 illustrates an even further enhanced embodiment of an auditory perception controlling device according to an embodiment of the present invention. It comprises an auditory perception controlling device 10 comprising a processing unit 11, a receiver 12 for receiving remote control command signals 14, an emitter 13 for emitting auditory perception controlling command signals 15, a microphone 41 for measuring sound 42 surrounding the auditory perception controlling device, and an input connector 51 for receiving an audio signal connection 52.

The advantageous and preferred embodiment of FIG. 6 facilitates all features mentioned above regarding any of the embodiments of FIGS. 1 to 5. In addition, the access to both a microphone and the audio signal from the audio system, whether processed or unprocessed, enables the processing unit to distinguish the sounds that originates from the audio system from other sounds originating from the environment, e.g. telephone ringing, conversation, children playing, pets, dishwashers and other machines, etc. A substantially accurate representation of these environment sounds may be established by essentially subtracting the processed or unprocessed audio signal from the microphone signal, even though the best result is obtained by using the processed audio signal and scaling it in correspondence with the microphone signal. The possibility of distinguishing the environmental sounds facilitates an improvement of the degree and accuracy by which the auditory perception controlling device is able to perform some of the above-mentioned functions, especially the recognition of, e.g., telephone ringing for the auto-mute functionality or voice commands for the voice control functionality. But also the estimation of the absolute loudness level caused by the audio system may be improved by being able to filter out the environment sounds.

A further feature facilitated by having access to both the microphone and audio signals is the possibility of performing auditory perception control of the audio system output on the basis of the loudness and type of environment sounds. Hence, when the loudness level of the background noise is high, the auditory perception controlling device may increase the volume, and hence the audio system loudness-level, according to the listener's desire, and possibly the selected listening mode and current time of day as it may not be desirable when using the audio system for, e.g., background music or, e.g., in the evening. The auditory perception controlling device may control the audio system merely on the basis of the loudness-level of the environment sounds or it may estimate the kind of environment sound and base the control on that. For example, the auditory perception controlling device may measure an environment sound almost as loud as the audio system output and estimate that the environment sound is most likely a machine, e.g. a dishwasher, etc., and thus increase the audio system volume in order to establish a significant, possibly user-defined by learning or manual setting, loudness difference. In another case, the auditory perception controlling device may measure an environment sound almost as loud as the audio system output and estimate that the environment sound is most likely a conversation, and thus maintain or even decrease the audio system volume according to predefined preferences. In an alternative embodiment, the auditory perception controlling device may determine that the intelligibility of the audio system output may be improved without necessarily increasing volume, but instead, or simultaneously, alter other parameters, e.g., equalization settings. Typically, a distinct intelligibility limit exists, and the auditory perception controlling device may thus be able to calculate proper settings for re-establishing intelligibility.

FIG. 7 illustrates an even further, alternative embodiment, wherein the auditory perception controlling device 10 is incorporated in a remote control 24, preferably a universal remote control. Thereby, the auditory perception controlling device does not need to capture the remote control command signal, but has immediate access to the user input. FIG. 7 comprises a combined remote control 24 and auditory perception controlling device 10, comprising a keypad 70, a processing unit 11, a remote control command unit 71 and an emitter 13, 31. The keypad 70 outputs a user input signal 72 to the processing unit 11, which processes the user input and establishes a intermediate command signal 73, which is mapped into a relevant remote control driving signal 74 by the remote control command unit 71 and further converted into remote control command signals 14 and auditory perception controlling command signals 15, which may actually be indistinguishable.

The embodiment of FIG. 7 is advantageous as the auditory perception controlling device and the remote control may share the input means, e.g. a keypad 70, the unit that maps commands into remote control signal corresponding to a certain audio system, e.g. a remote control command unit 71, and the emitter 13, 31. Furthermore, a remote control command receiver may be omitted, and the user possibly needs only one device for controlling everything. In addition to the fewer components and shared resources, the combined device enables the processing unit to access and adapt the user input before it is sent to the audio system. Thereby, the processing unit may overrule the user's inputs, or change them according to learned or predefined behaviours.

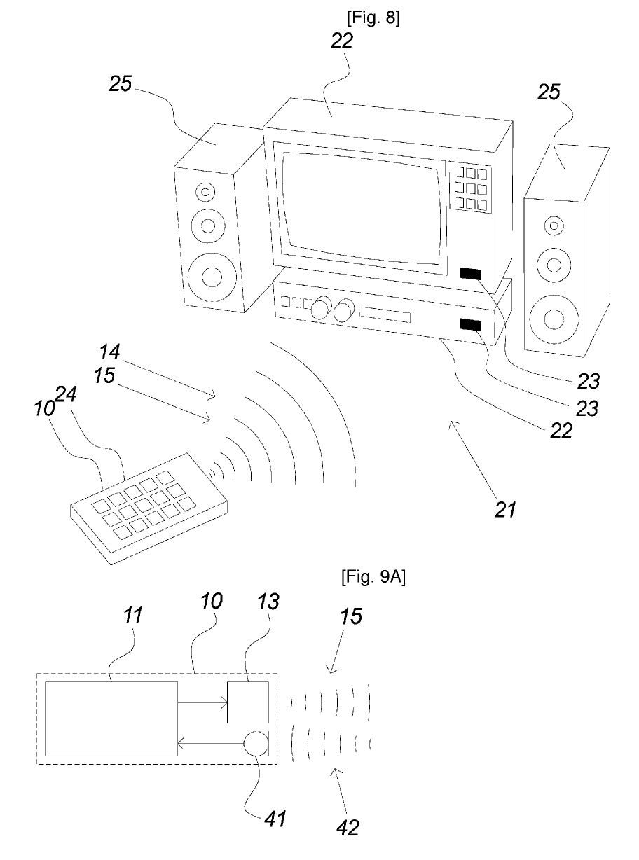

FIG. 8 illustrates an example of a practical set-up including a combined auditory perception controlling device 10 and remote control 24 as described above regarding FIG. 7. It comprises an audio system 21, in this example consisting of a couple of remote controllable audio subsystems 22, e.g. a television and a stereo amplifier with built-in radio receiver, and a couple of loudspeakers 25. The audio subsystems 22 each comprise a remote control receiver 23. Significant parameters, such as volume, audio source, TV- or radio channel, etc., of the audio system 21 may be controlled by means of the remote control 10, 24 by emission of, preferably infrared, remote control command signals 14 and/or auditory perception controlling command signals. The combined device 10, 24 preferably resembles the features of a universal remote control, i.e. facilitates operation of several different audio systems and audio subsystems of different brands.

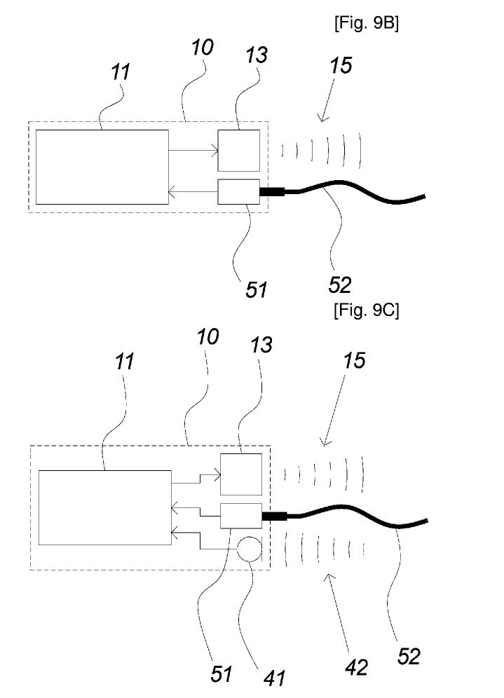

FIGS. 9A, 9B and 9C illustrate alternatives of a further embodiment of the present invention, where the auditory perception controlling device 10 does not comprise any remote control receiver. The only input to the device is thus a microphone 41 as in FIGS. 9A and 9C, and/or an input connector 51 for receiving an audio signal connection 52 as in FIGS. 9B and 9C, and/or buttons, knobs or other user input means. In the embodiments of FIG. 9A to 9C, the devices are not able to learn and repeat typical user behaviour. The devices are, however, able to control auditory perception properties on the basis of the sound picked up by the microphone 41, the sound signals processed by the audio system via the input connector 51, and, if both are present as in FIG. 9C, on the basis of the difference between the sound in the room and the sound produced by the audio system. The devices of FIGS. 9A to 9C may thus operate according to predefined algorithms, e.g. automatically decrease loudness and/or annoyance when commercial breaks occur, automatically increase loudness and/or intelligibility when high background noise is measured, etc. If provided with user input means, such as buttons, the devices may also learn behaviours as known from cruise controls in cars, where the user just has to tell the device when the desired auditory perception is obtained, and the device will seek to maintain that perception. The device may further, by means of buttons or by means of data connection facilities such as, e.g., a USB port facilitate programming and altering of the predefined algorithms and settings.

In alternative embodiments of the present invention, the auditory perception controlling device 10 is incorporated in other devices as an additional feature. Such a device may, e.g., comprise a headset for a mobile, wireless or wired telephone, where the auditory perception controlling feature may enable the headset to automatically mute a nearby remote controllable audio system when the telephone rings, or to automatically control auditory perception controlling parameters of the telephone, e.g. in order to adaptively improve intelligibility of the conversation. Another device in which the auditory perception controlling feature may be incorporated may, e.g., comprise a PDA or a laptop computer.

In alternative embodiments of the present invention, the auditory perception controlling device 10 comprises network connection means, e.g. for connecting to an Ethernet network or wireless network using the TCP/IP protocol suite. Such a network may comprise a local area network LAN within a home or even restricted to only connect the audio subsystems and loudspeakers of an audio system, or it may be a wide area network or even global network such as, e.g., the Internet. By providing the device with network access, the device may be accessed from, e.g., a computer or PDA connected to the same network, thereby facilitating improved user interface and control. By further providing the device with a small web-server, the device may be controlled from any web-browser having access to the same network. Besides control and configuration of the device itself, the network connection may be used for transmitting the remote control commands to the audio system and audio subsystems in setups where the audio system or one or more of the audio subsystems and loudspeakers also have network access. Furthermore, the network access may be used for receiving a processed or unprocessed audio signal from the audio system, as described above. By providing the device with access to the Internet, the algorithms and routines of the processing means 11 may easily be upgraded when error corrections or new versions are available, or specialised, optional algorithms may be downloaded when needed.

1. Method of automatically performing adjustment of audio control settings in an audio system comprising at least one remote controllable audio subsystem, whereby at least a part of said audio control settings is adjusted according to automatic audio control setting adjustment routines via at least one remote control receiver of said audio system.

2. Method according to claim 1, whereby said audio control settings control an auditory perception of audio established by said audio system.

3. Method according to claim 1, whereby said method involves obtaining a predetermined auditory perception of sound established by said audio system by said adjustment of audio control settings.

4.-6. (canceled)

7. Method according to claim 1, whereby said adjusting according to automatic audio control setting adjustment routines via said at least one remote control receiver is performed by an auditory perception controlling device.

8. Method according to claim 1, whereby said adjusting according to automatic audio control setting adjustment routines is at least partly based on data obtained by monitoring at least one input means, and whereby said auditory perception controlling device (10) comprises said input means.

9.-10. (canceled)

11. Method according to claim 1, whereby said adjusting according to automatic audio control setting adjustment routines is at least partly based on acquired information about at least one user's typical use of said audio system.

12. (canceled)

13. Method according to claim 1, whereby said adjusting according to automatic audio control setting adjustment routines is at least partly based on at least one of monitoring surrounding sound, monitoring a time, monitoring an audio signal from said audio system, or monitoring remote control signals from at least one remote control of said audio system.

14.-17. (canceled)

18. Method according to claim 8, whereby said adjusting according to automatic audio control setting adjustment routines is at least partly based on monitoring user input via user input means.

19. Method according to claim 1, whereby said method comprises learning at least one behaviour of at least one user of said audio system, associating each of said at least one behaviour with at least one condition, monitoring fulfilment of said at least one condition, and upon fulfilment of at least one of said at least one condition automatically repeating said associated behaviour, whereby said repeating a behaviour comprises automatically performing adjustment of audio control settings in said audio system.

20. Method according to claim 1, whereby said method comprises monitoring surrounding sound and upon said sound fulfilling predefined or user defined conditions automatically performing adjustment of audio control settings in said audio system.

21. Method according to claim 1, whereby said method comprises monitoring an audio signal of said audio system and upon said audio signal fulfilling predefined or user defined conditions automatically performing adjustment of audio control settings in said audio system.

22. Method according to claim 1, whereby said method comprises continuously monitoring fulfilment of one or more conditions regarding remote control signals, surrounding sound, audio signals from said audio system, time and/or user input and upon fulfilment automatically performing said adjustment of audio control settings in said audio system.

23. Method according to claim 1, whereby said method comprises automatically controlling at least one of a loudness, an intelligibility and/or an annoyance of sound established by said audio system.

24.-25. (canceled)

26. Method according to claim 1, whereby said audio control settings comprise gain settings, bass and treble settings, equalization settings, mute settings, mono, stereo or surround sound settings, and/or dynamic range control settings.

27.-33. (canceled)

34. Audio system comprising at least one remote controllable audio subsystem, audio control settings and at least one remote control receiver, wherein an auditory perception controlling device is arranged for automatically adjusting at least a part of said audio control settings via at least one of said at least one remote control receiver.

35. Audio system according to claim 34, wherein said auditory perception controlling device comprises a processing unit for performing said adjusting at least a part of said audio control settings according to automatic audio control setting adjustment routines.

36. Audio system according to claim 34, wherein said auditory perception controlling device comprises at least one emitter.

37.-41. (canceled)

42. Audio system according to claim 34, wherein said auditory perception controlling device comprises at least one input means.

43. Audio system according to claim 42, wherein said at least one input means comprises at least one receiver, at least one infrared light receiver, at least one microphone, at least one input connector, and/or at least one keypad.

44.-47. (canceled)

48. Audio system according to claim 34, wherein said adjusting at least a part of said audio control settings is performed according to automatic audio control setting adjustment routines.

49. Audio system according to claim 34, wherein said adjusting at least a part of said audio control settings is at least partly based on at least one of data obtained by monitoring at least one input means, acquired information about at least one user's typical use of said audio system, predefined routines, monitoring surrounding sound, monitoring a time, monitoring an audio signal from said audio system, monitoring remote control signals from at least one remote control comprised by said audio system, or monitoring user input via user input means.

50.-57. (canceled)

58. Audio system according to claim 34, wherein said audio system comprises at least one remote control and said auditory perception controlling device comprises a receiver, a processing unit and an emitter, wherein said receiver is arranged to cooperate with said at least one remote control, said emitter is arranged to cooperate with said remote control receiver, and said processing unit is arranged to learn at least one behaviour of at least one user of said audio system at least partly from data obtained by said receiver, to associate each of said at least one behaviour with at least one condition, to monitor fulfilment of said at least one condition, and upon fulfilment of at least one of said at least one condition to automatically repeat said associated behaviour at least partly by means of said emitter, wherein said repeating said associated behaviour comprises performing adjustment of said audio control settings in said audio system via said remote control receiver.

59. Audio system according to claim 34, wherein said auditory perception controlling device comprises a microphone, a processing unit and an emitter, wherein said microphone is arranged to measure surrounding sound, said emitter is arranged to cooperate with said remote control receiver, and said processing unit is arranged to automatically perform adjustment of said audio control settings in said audio system via said remote control receiver upon said surrounding sound fulfilling predefined or user defined conditions.

60. Audio system according to claim 34, wherein said auditory perception controlling device comprises an input connector, a processing unit and an emitter, wherein said input connector is arranged to receive an audio signal from said audio system, said emitter is arranged to cooperate with said remote control receiver, and said processing unit is arranged to automatically perform adjustment of said audio control settings in said audio system via said remote control receiver upon said audio signal fulfilling predefined or user defined conditions.

61. Audio system according to claim 34, wherein said auditory perception controlling device is arranged to continuously monitor fulfilment of one or more conditions regarding remote control signals, surrounding sound, audio signals from said audio system, time and/or user input and upon fulfilment automatically perform said adjustment of audio control settings in said audio system.

62. Audio system according to claim 34, wherein an auditory perception is controlled by controlling a loudness, an intelligibility and/or an annoyance of sound established by said audio system.

63.-64. (canceled)

65. Audio system according to claim 34, wherein said audio control settings comprise gain settings, bass and treble settings, equalization settings, mute settings, mono, stereo or surround sound settings, and/or dynamic range control settings.

66.-70. (canceled)

71. Audio system according to claim 34, wherein said auditory perception controlling device comprises a network interface.

72. Audio system according to claim 34, wherein said emitter and said remote control receiver comprise network interfaces.

73. Audio system according to claim 34, wherein said auditory perception controlling device is incorporated in a universal remote control.

74. Auditory perception controlling device comprising at least one input means, a processing unit and an emitter, wherein said processing unit cooperates with said emitter to establish remote control signals upon fulfilment of predefined, user defined or dynamically determined conditions regarding data received by at least one of said at least one input means, wherein at least one of said at least one input means comprises a receiver for receiving remote control signals, a microphone for measuring surrounding sound or an input connector for receiving an audio signal.

75. Auditory perception controlling device according to claim 74, wherein said remote control signals comprises auditory perception controlling command signals suitable for adjusting audio control settings of an audio system.

76. Auditory perception controlling device according to claim 74, wherein said remote control signals are established according to automatic audio control setting adjustment routines.

77. Auditory perception controlling device according to claim 74, wherein said auditory perception controlling device comprises a time tracking means and said conditions at least partly regard a time as provided by said time tracking means.

78. Auditory perception controlling device according to claim 74, wherein said auditory perception controlling device comprises a universal remote control.

79. Auditory perception controlling device according to claim 74, wherein said auditory perception controlling device comprises network interface means.
